(19) United States
(12) Patent Application Publication
(10) Pub. No.: US 2024/0140010 A1
(43) Pub. Date: May 2, 2024

(54) INFORMATION PROCESSING DEVICE, INJECTION MOLDING MACHINE, AND NON-TRANSITORY COMPUTER READABLE MEDIUM STORING PROGRAM

(71) Applicant: SUMITOMO HEAVY INDUSTRIES, LTD., Tokyo (JP)

(72) Inventors: Takuya MIZUNASHI, Chiba-shi (JP); Tomosuke KADOONO, Chiba-shi (JP)

(21) Appl. No.: 18/465,081

(22) Filed: Sep. 11, 2023

(30) Foreign Application Priority Data
Oct. 26, 2022 (JP) 2022-171488

(51) Int. Cl. B29C 45/76

(52) U.S. Cl. CPC B29C 45/76; B29C 2045/7606

(57) ABSTRACT

An information processing device displays information related to manufacturing of a molding product by an injection molding machine, and the information processing device includes: an acquisition unit that acquires information related to a shot in injection molding and estimated data of information indicating a molding result in the shot estimated based on information obtained in the shot; and a display unit that displays, for each shot, the information related to the shot and the estimated data in the shot in association with each other, based on the information acquired by the acquisition unit.

### CROSS-REFERENCE TO RELATED APPLICATIONS

This application claims priority to Japanese Patent Application No. 2022-171488, filed on Oct. 26, 2022, which is incorporated by reference herein in its entirety.

### BACKGROUND

### Technical Field

A certain embodiment of the present invention relates to an information processing device, an injection molding machine, and a non-transitory computer readable medium storing a program.

### Description of Related Art

The related art discloses generating an estimation model of a neural network based on time-series data acquired from a sensor provided in an injection molding machine or a die casting machine and on data of an inspection result obtained from an inspection device, and estimating the state of a product using the generated estimation model.

### SUMMARY

According to an embodiment of the present invention, there is provided an information processing device that displays information related to manufacturing of a molding product by an injection molding machine, the information processing device including: an acquisition unit that acquires information related to a shot in injection molding and estimated data of information indicating a molding result in the shot estimated based on information obtained in the shot; and a display unit that displays, for each shot, the information related to the shot and the estimated data in the shot in association with each other, based on the information acquired by the acquisition unit.

### BRIEF DESCRIPTION OF THE DRAWINGS

FIG. 1 is a diagram illustrating a configuration of an injection molding machine to which the present embodiment is applied.

FIG. 2 is a diagram illustrating a configuration of a control device.

FIG. 3 is a diagram illustrating a configuration of a data processing device.

FIG. 4 is a diagram illustrating a hardware configuration example of the control device and the data processing device.

FIG. 5 is a diagram illustrating a configuration example of a neural network as an example of an estimation model.

FIG. 6 is a diagram illustrating an example of a presentation screen of estimated data.

FIG. 7 is a diagram illustrating another example of a presentation screen of estimated data.

FIG. 8 is a diagram illustrating another example of a presentation screen of estimated data.

### DETAILED DESCRIPTION

It is required to perform inference using a computer based on an actual value for each shot regarding the manufacture of a product by an injection molding machine, and to utilize the obtained inference result for quality control of the product, condition setting in a manufacturing process, and the like.

It is desirable to make it possible to utilize an inference result obtained by inference using a computer regarding the manufacture of a product by an injection molding machine for quality control of the product, condition setting in a manufacturing process, and the like.

Hereinafter, an embodiment of the present invention will be described in detail with reference to the accompanying drawings.

### Device Configuration

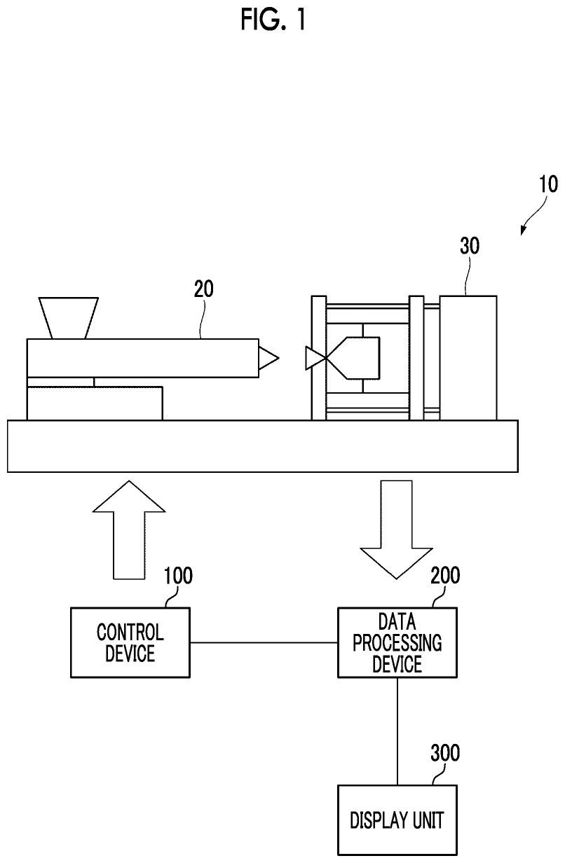

FIG. 1 is a diagram illustrating a configuration of an injection molding machine to which the present embodiment is applied. An injection molding machine 10 includes an injection unit 20, a mold clamping unit 30, a control device 100, a data processing device 200, and a display unit 300. In the following description, a direction from the injection unit 20 toward the mold clamping unit 30 may be referred to as forward.

The injection unit 20 includes a cylinder that heats a molding material, a screw that is rotatable in the cylinder and that is provided to be able to advance and retreat in an axial direction, a rotary motor that drives the screw in a rotational direction, a motor that drives the screw in the axial direction, and the like. The molding material is, for example, a resin or the like. The injection unit 20 advances forward while rotating the screw to inject the molding material heated and liquefied within the cylinder, and fills a mold of the mold clamping unit 30 disposed in front of the injection unit 20. The injection unit 20 performs, for example, a plasticizing process, a filling process, a holding pressure process, and the like in a manufacturing process of a molding product. The filling process and the holding pressure process may be collectively referred to as an injection process.

The mold clamping unit 30 includes a mold, a tightening mechanism for tightening the mold, a motor for driving the tightening mechanism, and the like. The mold clamping unit 30 closes the mold and receives the molding material injected from the injection unit 20 into the inside of the mold. In this case, the mold clamping unit 30 tightens the mold with a tightening mechanism such that the mold does not open due to the filling of the molding material (mold clamping). A molding product is produced by solidifying the molding material filled in the mold. After that, the mold clamping unit 30 opens the mold, and the produced molding product can be taken out. The mold clamping unit 30 performs, for example, a mold closing process, a pressurizing process, a mold clamping process, a depressurizing process, a mold opening process, and the like in a manufacturing process of a molding product.

The control device 100 is a device that controls the operations of the injection unit 20 and the mold clamping unit 30. The data processing device 200 is a device that processes data obtained as the injection unit 20 and the mold clamping unit 30 operate. The display unit 300 displays information related to the control of the injection unit 20 and the mold clamping unit 30 by the control device 100, data acquired by the data processing device 200, a processing result of the data processing device 200, and the like. In addition, the display unit 300 displays an operation screen for performing an operation of inputting commands or data to the control device 100 or the data processing device 200.

### Configuration of Control Device 100

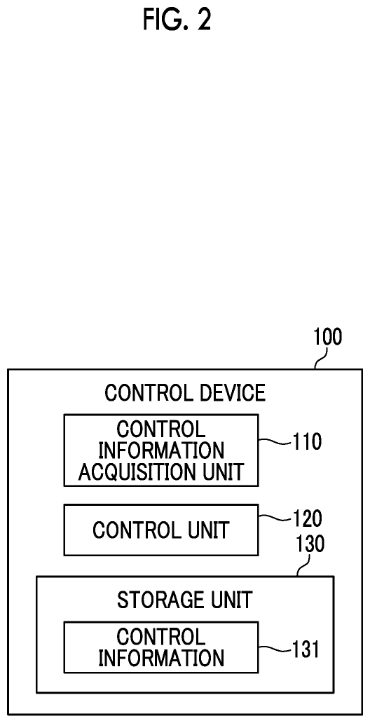

FIG. 2 is a diagram illustrating a configuration of the control device 100. The control device 100 controls the operations of the injection unit 20 and the mold clamping unit 30. For example, the control device 100 is implemented by a computer. The control device 100 includes a control information acquisition unit 110, a control unit 120, and a storage unit 130. The control device 100 controls the injection unit 20 and the mold clamping unit 30 to repeatedly perform processes related to the manufacture of a molding product, thereby repeatedly manufacturing the molding product. Processes related to the manufacture of a molding product include a plasticizing process, a mold closing process, a pressurizing process, a mold clamping process, a filling process, a holding pressure process, a cooling process, a depressurizing process, a mold opening process, an ejecting process, and the like. Hereinafter, these processes related to the manufacture may be collectively referred to as a “manufacturing process”. A series of operations for obtaining the molding product, for example, an operation from the start of the plasticizing process in the manufacturing process to the start of the next plasticizing process, is referred to as a “shot”, a “molding cycle”, or the like. Further, each of the above-described processes for manufacturing a molding product is merely an example. For example, the process executed in one shot may include other processes not included in the above processes.

The control information acquisition unit 110 acquires control information used to control the injection unit 20 and the mold clamping unit 30. The control information is a condition set by a user, and is input by the user using, for example, an input unit (not illustrated). The control information includes, for example, molding conditions such as a resin temperature (cylinder temperature), a mold temperature, an injection holding pressure time, a plasticizing value, a V-P switching position, a holding pressure, an injection speed (filling speed), a screw rotation speed, a screw back pressure, and a mold clamping force. A plurality of combinations of these molding conditions are determined according to the molding product and the mold. This combination data of the molding conditions will be hereinafter referred to as a molding condition data set. The control information acquisition unit 110 stores the acquired control information in the storage unit 130 as a molding condition data set.

The control unit 120 controls the injection unit 20 and the mold clamping unit 30 using the above-described molding condition data set, and performs processes related to the manufacture (shot) of a molding product including each of the above-described processes. The control unit 120 reads the molding condition data set corresponding to the molding product to be manufactured from the storage unit 130 at the time of starting the manufacturing of the molding product or the like. Then, the control unit 120 controls the operations of the injection unit 20 and the mold clamping unit 30 based on the read control information. Specifically, the control unit 120 controls the injection unit 20 and the mold clamping unit 30 such that the data obtained from the injection unit 20 and the mold clamping unit 30 in the manufacturing process match setting values of the molding condition data set. In addition, the control unit 120 may cause the display unit 300 to display the molding condition data set read from the storage unit 130. The user may refer to the data of the molding condition displayed on the display unit 300 and perform an operation such as correction of the value as necessary.

The storage unit 130 holds the control information 131 acquired by the control information acquisition unit 110. The molding condition data set included in the control information 131 is prepared in association with the molding product or the mold to be manufactured. The storage unit 130 holds a molding condition data set for each molding product or mold to be manufactured. Further, although not illustrated, the storage unit 130 holds a program for the control unit 120 to control the injection unit 20 and the mold clamping unit 30. As will be described in detail later, the function of the control unit 120 is implemented by a processor reading and executing the program held in the storage unit 130 in the control device 100.

### Configuration of Data Processing Device

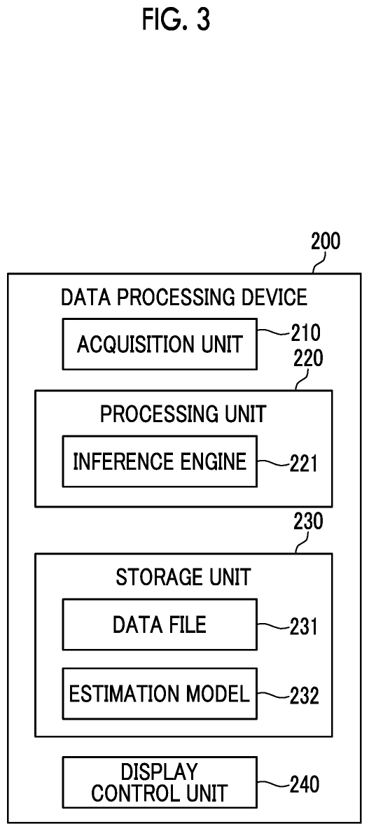

FIG. 3 is a diagram illustrating a configuration of the data processing device 200. The data processing device 200 acquires and processes data obtained as the injection unit 20 and the mold clamping unit 30 execute the operations in the process related to the manufacture of the molding product. The data processing device 200 is implemented by, for example, a computer. The data processing device 200 includes an acquisition unit 210, a processing unit 220, a storage unit 230, and a display control unit 240.

The acquisition unit 210 acquires data to be processed from the injection unit 20 and the mold clamping unit 30. Various sensors and detectors are attached to the injection unit 20 and the mold clamping unit 30. The data acquired by these sensors and detectors (hereinafter referred to as “acquired data”) is information indicating a molding result by the injection unit 20 and the mold clamping unit 30, and is used for quality control of a molding product. Specifically, for example, the weight of the molding product, the dimensions of the molding product, the mold internal pressure, the position of the minimum cushion, the characteristic amount of the waveform of the filling pressure, and the like are included. These pieces of acquired data are actual values obtained in the manufacturing process of the molding product. As will be described in detail later, some data items of these pieces of acquired data may not be measured or plasticized, or data may be generated by inference while acquiring data through measurement or plasticizing. The acquisition unit 210 receives acquired data transmitted from the sensors or the detectors, and stores the acquired data in the storage unit 230. In addition, these pieces of acquired data may be used for control by the control unit 120.

The processing unit 220 processes the acquired data stored in the storage unit 230. Specifically, the processing unit 220 performs a process of extracting a representative value of the acquired data in each process and generating time-series data in which the acquired data in each process is time-series. In the extraction of the representative value, the processing unit 220 performs statistical processing on the acquired data, such as calculation of an average value, specification of a range within which the value is taken, and specification of a maximum value and a minimum value. The processing unit 220 also includes an inference engine 221. The inference engine 221 estimates part of the data representing the molding result. As long as the inference engine 221 estimates the value of some other data using some of the data items of the acquired data, the type and the estimation method are not particularly limited. As an example, it is conceivable to estimate the data using an estimation model generated by a neural network, a decision tree, or other machine learning. As an estimation model that is not machine learning, for example, a multivariate analysis model such as a multiple regression model is used. Here, as an example, the inference engine 221 estimates data using an estimation model 232 based on machine learning.

The data estimated by the inference engine 221 (hereinafter referred to as “estimated data”) is part of the above-described data items as acquired data. For example, data such as a value representing a state of a molding product, a value representing a state of a mold, a value representing a state of the injection unit 20 and the mold clamping unit 30, a recommended value of a setting value for the molding conditions, a recommended value of an amount of change in the molding conditions, and the like may be used as estimated data. For data items of the estimated data estimated by the inference engine 221, an actually measured value may be obtained by performing measurement or plasticizing via a sensor or a detector, or measurement or plasticizing may not be performed. For data items such as the weight and dimensions of the molding product, which are obtained by taking out the actually generated molding product and separately measuring it, by performing only the estimation without performing the actual measurement, it is possible to reduce the labor required for the actual measurement.

Further, the processing unit 220 determines whether or not the acquired data and the estimated data satisfy a predetermined condition. Specifically, the processing unit 220 sets a threshold that defines a range of acquired data and estimated data obtained when the quality of the molding product, the state of the mold or the device, or the like is normal, and determines whether or not the acquired data and the estimated data exceed the threshold. Accordingly, it is possible to monitor whether or not an abnormality has occurred in the quality of the molding product, the state of the mold or the device, or the like.

The storage unit 230 holds a data file 231 of the acquired data acquired by the acquisition unit 210 and the estimated data estimated by the inference engine 221. The data file 231 is held in association with a molding product or a mold to be manufactured in the shot from which the acquired data was obtained. The storage unit 230 also holds representative values, time-series data, statistical data, and the like processed by the processing unit 220. These pieces of data are associated with, for example, the original acquired data. Specifically, these pieces of data may be stored in the data file 231 of the corresponding original acquired data. In addition, a data file storing these pieces of data may be associated with the data file 231 of the original data. Accordingly, each piece of data generated by the processing unit 220 is also held in association with the molding product or the mold to be manufactured in the shot from which the original acquired data was obtained. For example, comma-separated values (CSV), Extensible Markup Language (XML), JavaScript Object Notation (JSON), or the like can be used as the data format of the data file 231 held in the storage unit 230.

The storage unit 230 also holds the estimation model 232 used by the inference engine 221 of the processing unit 220 to estimate part of data representing the molding result. Further, although not illustrated, the storage unit 230 holds a program for the processing unit 220 to execute data processing. As will be described in detail later, the function of the processing unit 220 is implemented by the processor reading and executing the program held in the storage unit 230 in the data processing device 200.

The display control unit 240 causes the display unit 300 to display the acquired data and the data of the processing result obtained by the processing unit 220. The data of the processing result obtained by the processing unit 220 includes the estimated data estimated by the inference engine 221. The display control unit 240 causes the display unit 300 to display the estimated data in association with the shot from which the acquired data used for estimating the estimated data was obtained. Here, displaying the data in association therewith is to display the acquired data such that the user can see the screen displayed on the display unit 300 and recognize that the data is the corresponding data. For example, in the case of displaying the data in a tabular format, acquired data obtained in each shot may be displayed side by side in the same row or column as the shot from which the acquired data was obtained, the acquired data may be grouped for each shot and a frame may be drawn and displayed such that the data included in the same group can be identified, the acquired data may be displayed by aligning a display mode such as the color, font, size, or background of characters to be displayed for each piece of corresponding data, or the acquired data may be displayed by a display method such as visually connecting the corresponding data with lines or the like. The data to be displayed also includes setting information in the control information used by the control device 100 to control the injection unit 20 and the mold clamping unit 30. The setting information (setting values) can be acquired from the control device 100. The display control unit 240 acquires these pieces of data from the storage unit 230 or the storage unit 130 of the control device 100, and causes the display unit 300 to display them.

### Hardware Configuration of Control Device and Data Processing Device

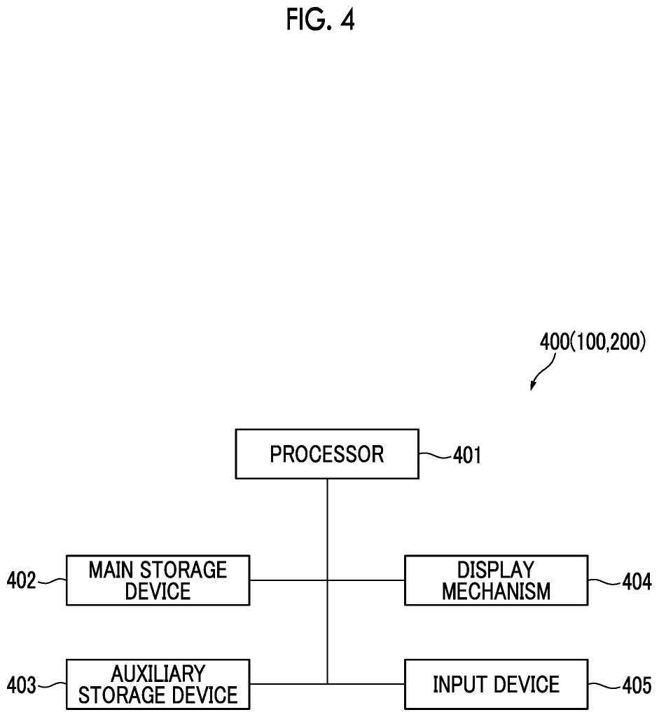

FIG. 4 is a diagram illustrating a hardware configuration example of a computer 400 that implements the control device 100 and the data processing device 200. The computer illustrated in FIG. 4 includes a processor 401 as calculation means, and a main storage device (main memory) 402 and an auxiliary storage device 403 as storage means. As the processor 401, for example, various arithmetic circuits such as a central processing unit (CPU), a graphics processing unit (GPU), an application-specific integrated circuit (ASIC), and a field-programmable gate array (FPGA) are used. The processor 401 reads a program stored in the auxiliary storage device 403 into the main storage device 402 and executes the program. As the main storage device 402, for example, a random-access memory (RAM) is used. As the auxiliary storage device 403, for example, a magnetic disk device, a solid-state drive (SSD), or the like is used. The computer also includes a display mechanism 404 for outputting a display on the display unit (display) 300, and an input device 405 on which an input operation is performed by a user of the computer. For example, a keyboard, a mouse, or the like is used as the input device 405. The configuration of the computer illustrated in FIG. 4 is merely an example, and the computer used in the present embodiment is not limited to the configuration example illustrated in FIG. 4. For example, a configuration including a non-volatile memory such as a flash memory or a read-only memory (ROM) as a storage device may be used.

When the control device 100 is implemented by the computer illustrated in FIG. 4, the control information acquisition unit 110 is implemented by, for example, the processor 401 and the input device 405 that read and execute the program. The function of the control unit 120 is implemented by, for example, the processor 401 reading and executing the program. The storage unit 130 is implemented by, for example, the auxiliary storage device 403.

When the data processing device 200 is implemented by the computer illustrated in FIG. 4, the functions of the acquisition unit 210 and the processing unit 220 are implemented by, for example, the processor 401 reading and executing the program. The storage unit 230 is implemented by, for example, the auxiliary storage device 403. The display control unit 240 is implemented by the processor 401 and the display mechanism 404 that read and execute the program.

### Configuration Example of Estimation Model

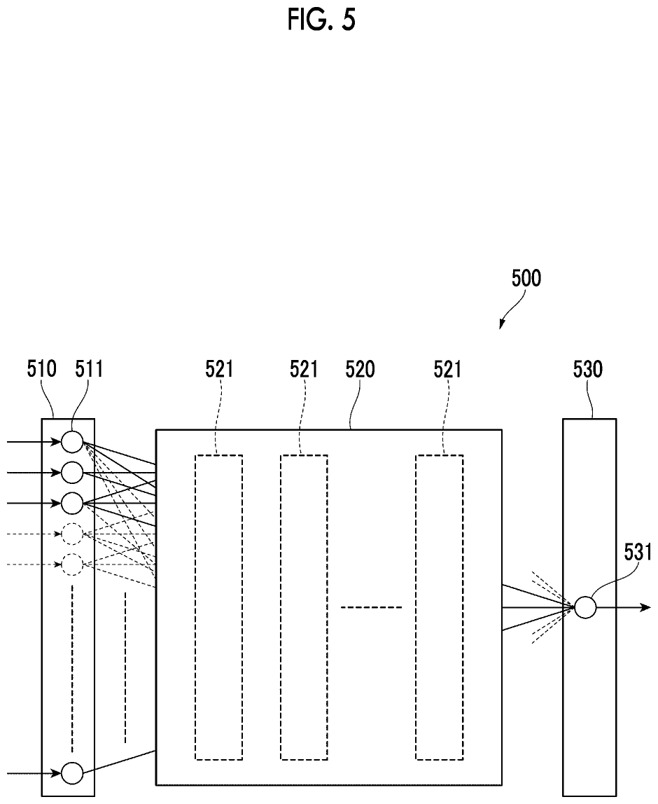

FIG. 5 is a diagram illustrating a configuration example of a neural network as an example of the estimation model 232. A neural network 500 constituting the estimation model 232 includes an input layer 510, a hidden layer 520, and an output layer 530. In the example illustrated in FIG. 5, the input layer 510 includes input units 511 corresponding to the number of elements used for inference among the acquired data obtained in one shot and the data of the processing result. In FIG. 5, the input units 511 are indicated by circle marks “◯”. The acquired data and the data of the processing result by the processing unit 220 are input to the input layer 510. The hidden layer 520 has a multi-layer structure including a plurality of hidden layers 521. The output layer 530 includes one output unit 531 and outputs an estimated value (estimated data) of data representing a molding result which is an inference target (hereinafter referred to as “inference target data”).

The estimation model 232 is prepared for each type of inference target data. In the estimation model 232 corresponding to each piece of inference target data, the input units 511 of the input layer 510 are individually associated with a plurality of pieces of input data used for estimating the inference target data. As the input data, a representative value of the acquired data obtained by the sensor or the detector in each process of the corresponding shot may be used, or time-series data for each process of the acquired data may be used. Which type of data is used as the input data can be set according to the type of inference target data. The inference engine 221 of the processing unit 220 of the data processing device 200 reads the estimation model 232 for each type of inference target data from the storage unit 230, inputs data corresponding to the input data of the read estimation model 232 from the acquired data and the data of the processing result obtained by the processing unit 220, and estimates the value of each piece of inference target data.

### Display Example of Estimated Data

Next, a display example of estimated data estimated by the inference engine 221 will be described. The display control unit 240 of the data processing device 200 generates a presentation screen on which the estimated data obtained in each shot is described, and causes the display unit 300 to display the presentation screen. The presentation screen displays the estimated data and other information related to the same shot in association with each other. By referring to the estimated data displayed on the presentation screen, the user can utilize the estimated data in an operation related to the production of the molding product by the injection unit 20 and the mold clamping unit 30.

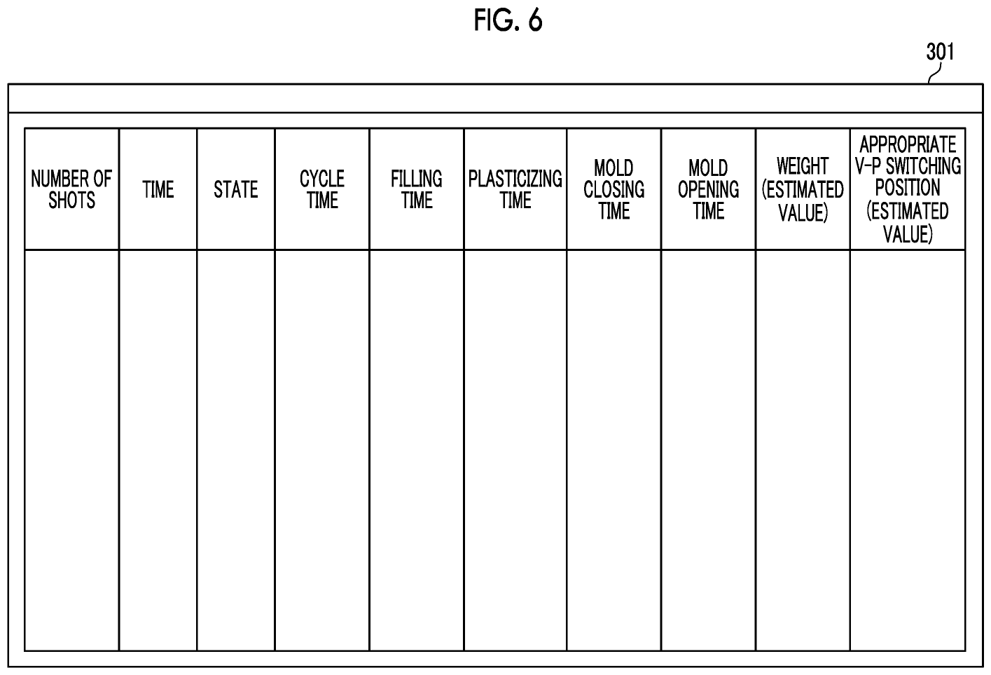

FIG. 6 is a diagram illustrating an example of a presentation screen of estimated data. A presentation screen 301 illustrated in FIG. 6 is configured to identify estimated data for each shot. More specifically, on the presentation screen 301 illustrated in FIG. 6, information obtained in a plurality of shots is displayed in a list, and information that can be used to identify each shot among information related to the shots and estimated data obtained in each shot are displayed in association with each other. On the presentation screen 301 illustrated in FIG. 6, “number of shots”, “time”, and “state” are illustrated for each shot, and information on actual values and estimated data are displayed in association with these pieces of information.

The “number of shots” is a shot number that is counted up for each shot, and is an example of identification information of each shot in the present embodiment. On the presentation screen 301 illustrated in FIG. 6, the “number of shots” that can be used to identify the shots is associated with the estimated data and other information related to the shots. The “time” is a time when the manufacturing process related to each shot is started. The time can also be utilized as identification information depending on the notation format, and is an example of the identification information displayed in a YYYYMMDDSS format in the present embodiment. The number of shots or the time may be used for identification, or a combination thereof may be used for identification. Further, identifiable information such as an identifier may be added and displayed separately from the number of shots and the time. The “state” is information indicating whether the manufactured molding product is good or defective. For example, when the molding product is defective, information indicating the defect is displayed. As the information indicating the defect, for example, a character “E”, which means an error, may be displayed. In addition, a circle mark “◯” may be displayed when the product is a good product, and a cross mark “×” may be displayed when the product is defective.

In addition, on the presentation screen 301 illustrated in FIG. 6, as actual values obtained by performing the manufacturing process for each shot, “cycle time”, “filling time”, “plasticizing time”, “mold closing time”, and “mold opening time” are illustrated. The “cycle time” is a time required to perform the manufacturing process of one shot. The “filling time” is a time required for the filling process of filling the mold of the mold clamping unit 30 with the molding material in the manufacturing process of one shot. The “plasticizing time” is a time required for the plasticizing process of driving a plasticizing motor (not illustrated) to feed the molding material in the manufacturing process of one shot. The “mold closing time” is a time required for the mold closing process of closing the mold prior to filling the molding material in the manufacturing process of one shot. The “mold opening time” is a time required for the mold opening process of opening the mold after the molding material filled in the mold is solidified in the manufacturing process of one shot.

Further, on the presentation screen 301 illustrated in FIG. 6, “weight” and “appropriate V-P switching position” are illustrated as the estimated data (denoted as “estimated value” in FIG. 6). The “weight” is a weight of the manufactured molding product. Here, an estimated value estimated by the inference engine 221 is displayed instead of an actually measured value obtained by extracting the manufactured molding product and actually measuring the weight. The “appropriate V-P switching position” is a value estimated as an appropriate value with respect to the switching position between the injection speed control and the injection pressure control in the injection molding.

Each piece of data including the above-mentioned actual value and estimated data is obtained for each shot, and each piece of data is displayed in association with the shot from which the data is obtained on the presentation screen 301 illustrated in FIG. 6. Specifically, for example, each piece of data obtained in the shots identified by the number of shots is displayed alongside the display of the number of shots on the presentation screen 301. Therefore, the actual value obtained in a certain shot is displayed side by side with the number of shots specifying the shot, and the estimated data estimated based on the actual value is displayed side by side with the number of shots specifying the shot and the actual value obtained in the shot.

In the example illustrated in FIG. 6, although the “weight”, which is one of the values representing the state of the product, and the “appropriate V-P switching position”, which is one of the setting values of the molding conditions, are estimated and displayed on the presentation screen 301 as estimated data, in addition to this, a value representing the state of the mold, values representing the states of the injection unit 20 and the mold clamping unit 30, and the like may be estimated and displayed on the presentation screen 301 as estimated data.

Further, it has been described above that the processing unit 220 of the data processing device 200 monitors whether or not the acquired data and the estimated data satisfy a predetermined condition. The determination result obtained in the processing unit 220 may be reflected on the presentation screen 301. For example, when there is data that exceeds a threshold indicating a normal range among the actual value which is the acquired data and the estimated data estimated based on the actual value, the corresponding data may be displayed in a display mode different from that of other data.

In the injection molding machine, a process called logging is performed in which the actual value obtained in the manufacturing process is saved for each shot. The data saved by logging can be displayed in a list on a display unit and can be utilized by the user for quality control or the like. As illustrated in FIG. 6, by displaying the estimated data together with the actual value for each shot, the user can refer to the estimated data on a screen similar to the display screen of the familiar logging data and determine the quality of the molding product, the state of the mold, the state of the device, and the like.

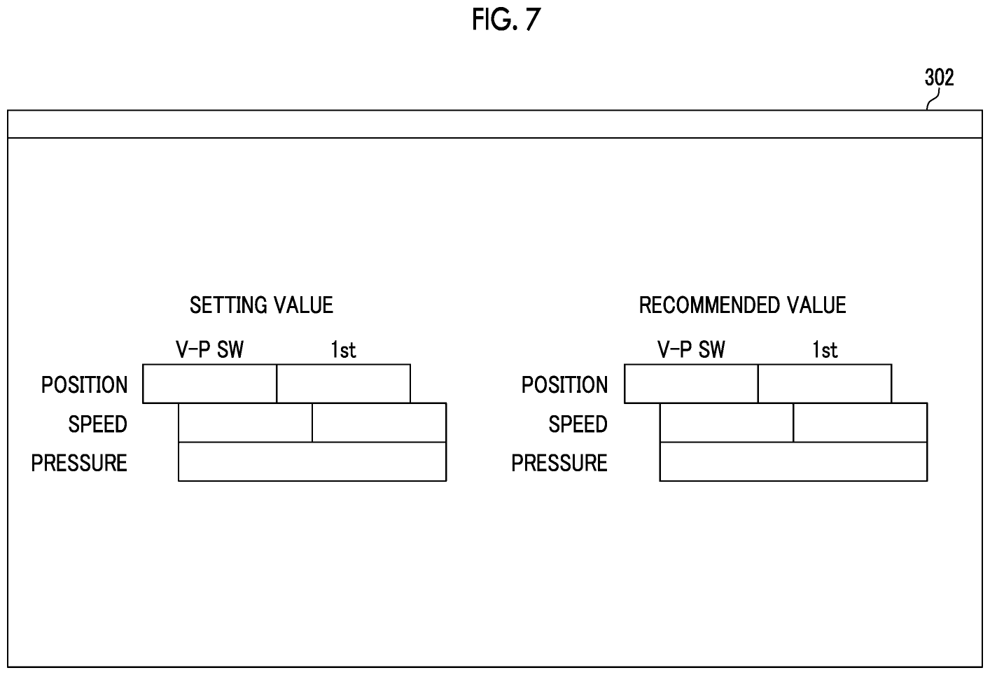

FIG. 7 is a diagram illustrating another example of a presentation screen of estimated data. On a presentation screen 302 illustrated in FIG. 7, regarding the setting of the filling process in the manufacturing process, the “setting value” and the “recommended value” are displayed in comparison with each other. The “setting value” is information related to the shot, and is a value input by the user. The “recommended value” is a value (estimated data) estimated by the inference engine 221. On the presentation screen 302 illustrated in FIG. 7, regarding the switching between the injection speed control and the injection pressure control (denoted as “V-P SW” in FIG. 7), for each of a switching position (denoted as a “position” in FIG. 7), a filling speed at the time of switching (denoted as a “speed” in FIG. 7), and a filling pressure at the time of switching (denoted as a “pressure” in FIG. 7), a display field of the setting value and a display field of the recommended value are displayed in association with each other. In the example illustrated in FIG. 7, in each display field of the setting value and the recommended value, the corresponding items are displayed such that the correspondence relationship can be visually recognized by disposing the items so as to have the same positional relationship. Further, although the frame in which each item is displayed is connected in each display field of the setting value and the recommended value in FIG. 7, the frames of each item may be separately disposed to form a gap. The user can input the setting value of each item or correct the input setting value with reference to the recommended value which is the value estimated by the inference engine 221. The presentation screen 302 illustrated in FIG. 7 may be configured using, for example, a screen in which the control device 100 inputs a setting value of the molding condition as control information.

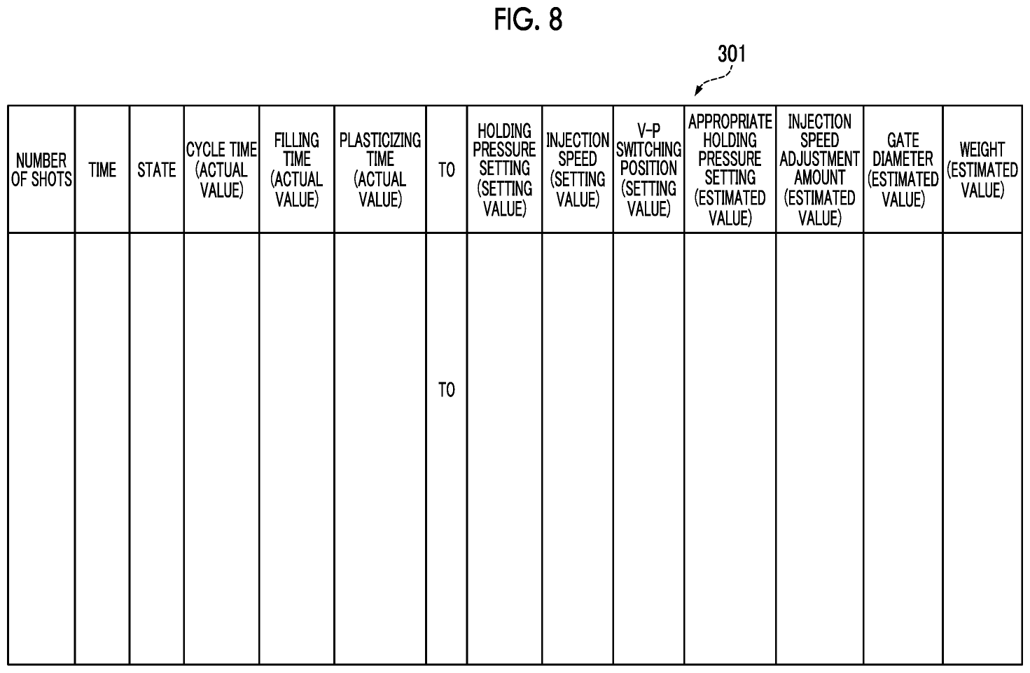

FIG. 8 is a diagram illustrating another example of a presentation screen of estimated data. The example illustrated in FIG. 8 is an example of a similar screen as the presentation screen 301 illustrated in FIG. 6, but with different data items presented. In FIG. 8, only the display fields for each piece of data are illustrated. In the example illustrated in FIG. 8, for each of a plurality of shots, each item of information related to each shot, an actual value, a setting value, and an estimated value is illustrated. In addition, in FIG. 8, only some of the items of the actual value and the setting value are illustrated, and the other items are omitted.

In the example illustrated in FIG. 8, as the information related to each shot, the same “number of shots”, “time”, and “state” as in FIG. 6 are illustrated. In addition, the illustrated items in the actual value are “cycle time”, “filling time”, and “plasticizing time”, which are the same as the items of the actual value illustrated in FIG. 6.

In the example illustrated in FIG. 8, “holding pressure setting”, “injection speed”, and “V-P switching position” are illustrated as setting values. The “holding pressure setting” is a setting value of the holding pressure in the holding pressure process. The “injection speed” is a setting value of the injection speed of the molding material in the injection process. The “V-P switching position” is a setting value of the switching position between the injection speed control and the injection pressure control. On the presentation screen 301 of FIG. 6, an estimated value (“appropriate V-P switching position”) is illustrated for the switching position between the injection speed control and the injection pressure control. However, the example of FIG. 8 illustrates a setting value for this parameter.

Further, in the example illustrated in FIG. 8, “appropriate holding pressure setting”, “injection speed adjustment amount”, “gate diameter”, and “weight” are illustrated as estimated data. The “appropriate holding pressure setting” is an estimated value of the holding pressure setting value. The “injection speed adjustment amount” is an estimated value of the adjustment amount with respect to the setting value of the injection speed. The “gate diameter” is an estimated value of the gate diameter of the mold. The “weight” is an estimated value of the weight of the molding product to be manufactured. In these estimated values, the “appropriate holding pressure setting” and the “injection speed adjustment amount” are estimated values of the setting values that are the molding conditions. The “gate diameter” is an estimated value for a parameter related to the mold. The “weight” is an estimated value for a parameter representing the quality of the molding product.

On the presentation screen 301 illustrated in FIGS. 6 and 8, each piece of data of the data items to be displayed is displayed in association with the number of shots from which the data was obtained. Specifically, for example, on the presentation screen 301 of FIG. 6, the data of each data item of “cycle time”, “filling time”, “plasticizing time”, “mold closing time”, and “mold opening time”, which are actual values, and “weight” and “appropriate V-P switching position”, which are estimated data, are displayed so as to be aligned in a horizontal direction with respect to the corresponding “number of shots”. By displaying the data in this manner, the user who refers to the presentation screen 301 can recognize, for each shot, what values are obtained as estimated data for “weight” and “appropriate V-P switching position” when the corresponding actual values are obtained.

Also, on the presentation screen 301, data of the actual value and the estimated value of each item corresponding to the last shot are added each time the manufacturing process of one shot is performed. At this time, the data of each item corresponding to the previous shots is sequentially sent on the presentation screen 301. Therefore, the data of each item is arranged in a vertical direction in the order of shots. Specifically, for example, in a case where each piece of data based on the last performed shot is displayed directly above each piece of data based on the most recently performed shot, and each piece of data based on the previously performed shot is displayed in order downward, when one data item is focused on, new data is displayed in order from the bottom to the top.

When a molding product is manufactured by the injection molding machine 10, the operation of the injection molding machine 10 includes an operation for specifying a setting value of an appropriate molding condition (hereinafter referred to as an “operation at the time of setting the condition”) and an operation when the setting values of the molding conditions are specified and the molding products are mass-produced (hereinafter referred to as an “operation at the time of mass production”). In the operation at the time of setting the condition, the user can narrow down the appropriate setting values by performing the manufacturing process while changing the setting values for each shot and referring to the changes in the estimated values displayed in association. Further, in the operation at the time of mass production, the user can check the estimated values for each shot regarding parameters, such as the weight of the molding product, which greatly affect the quality of the molding product, and when a large change is detected, can assume that an abnormality has occurred and take action. By using the estimated value, it is possible to save the labor of extracting the manufactured molding product and actually measuring the weight or the like.

Here, the data that can be acquired as the actual value is the data acquired by the acquisition unit 210 of the data processing device 200 from the sensors and detectors provided in the injection unit 20 and the mold clamping unit 30. Therefore, the type of data that can be displayed as the actual value on the presentation screen 301 is specified by sensors and detectors provided in the injection unit 20 and the mold clamping unit 30. In addition, the setting value is data recorded as molding conditions in the control information held in the storage unit 130 of the control device 100. Therefore, the type of data that can be displayed as the setting value on the presentation screen 301 is specified based on the molding conditions required for the control of the injection unit 20 and the mold clamping unit 30. Further, the estimated data is data obtained by performing inference using the estimation model 232 held in the storage unit 230 by the inference engine 221 in the processing unit 220 of the data processing device 200. Therefore, the type of data that can be displayed as inference data on the presentation screen 301 is specified according to the prepared estimation model 232. However, on the presentation screen 301 displayed on the display unit 300, the user can set whether or not to display each data item and the display order of the data items to be displayed.

With reference to the presentation screen 301 illustrated in FIGS. 6 and 8, on the presentation screen 301 illustrated in FIG. 6, “cycle time”, “filling time”, “plasticizing time”, “mold closing time”, and “mold opening time” are displayed as actual values, and “weight” and “appropriate V-P switching position” are displayed as estimated data. On the other hand, on the presentation screen 301 illustrated in FIG. 8, “cycle time”, “filling time”, and “plasticizing time” are displayed in part as actual values, “holding pressure setting”, “injection speed”, and “V-P switching position” are displayed in part as setting values, and “appropriate holding pressure setting”, “injection speed adjustment amount”, “gate diameter”, and “weight” are displayed as estimated data.

Although the embodiment of the present invention has been described above, the technical scope of the present invention is not limited to the above-described embodiment. For example, in the above-described embodiment, the injection molding machine 10 has been described as a configuration including the data processing device 200 and the display unit 300. However, the present invention is not limited to such a configuration. For example, a display of an external device connected to the data processing device 200 may be used as the display unit 300, and the presentation screens 301 and 302 may be displayed on the display. Further, the function of the display control unit 240 of the data processing device 200 and the function of the display unit 300 may be implemented by an information processing device such as a personal computer, and the information processing device may acquire data such as acquired data, setting values, and estimated data from the data processing device 200 and display the presentation screens 301 and 302. Further, the data processing device 200 and the display unit 300 may be implemented by an information processing device such as a personal computer, the information processing device may acquire setting information from the control device 100, acquire actual values from the injection unit 20 and the mold clamping unit 30 to estimate estimated data, and display the presentation screens 301 and 302 on the display of the information processing device.

Alternatively, the data processing device 200 may be implemented by an external server and connected to the injection molding machine 10 and the display unit 300 via a network. The external server may be a local server connected to the network, or may be a cloud server constructed in a so-called cloud environment on the network. Moreover, the external server may be applied as a server that configures the injection molding machine 10 or a management system that manages the molding product. Examples of this management system include a system that manages a plurality of injection molding machines and that performs quality control of molding products using logging data, a system that performs production management based on information such as the progress of the manufacturing process of the molding product and the operating state of the injection molding machine, and the like. The present embodiment may be implemented as a configuration in which the presentation screens 301 and 302 are displayed on the display unit 300 based on the information and the processing result handled by the server in these management systems.

Further, in the above-described embodiment, the estimated data estimated by the inference engine 221 is displayed on the presentation screens 301 and 302, but statistical processing may be performed on the estimated data as necessary to calculate statistical information such as the average value of the estimated values, the range including the estimated values, and the maximum value and the minimum value of the estimated values, and the calculated information may be displayed on the presentation screens 301 and 302. It should be understood that the invention is not limited to the above-described embodiment, but may be modified into various forms on the basis of the spirit of the invention. Additionally, the modifications are included in the scope of the invention.

What is claimed is:

1. An information processing device that displays information related to manufacturing of a molding product by an injection molding machine, the information processing device comprising:
an acquisition unit that acquires information related to a shot in injection molding and estimated data of information indicating a molding result in the shot estimated based on information obtained in the shot; and
a display unit that displays, for each shot, the information related to the shot and the estimated data in the shot in association with each other, based on the information acquired by the acquisition unit.

2. The information processing device according to claim 1, wherein
the information related to the shot includes identification information of the shot that identifies the shot, and
the display unit displays the identification information and the estimated data in the shot identified by the identification information in association with each other.

3. The information processing device according to claim 2, wherein
the acquisition unit further acquires an actual value of information indicating a molding result obtained by an operation of the injection molding in the shot, and
the display unit displays the actual value together with the estimated data in association with the identification information of the shot.

4. The information processing device according to claim 2, wherein
the acquisition unit further acquires setting information of an operation of the injection molding in the shot, which is used in the operation, and
the display unit displays the setting information together with the estimated data in association with the identification information of the shot.

5. The information processing device according to claim 1, wherein
the acquisition unit acquires statistical information obtained by performing statistical processing on the estimated data, and
the display unit displays the statistical information of the estimated data.

6. The information processing device according to claim 1, wherein the display unit displays the estimated data satisfying a predetermined condition regarding a state of the molding product in a display mode different from other display information when the estimated data to be displayed satisfies the condition.

7. The information processing device according to claim 1, wherein
the display unit displays the information related to the shot and the estimated data associated with the shot side by side for a plurality of shots, and
in the display on the display unit, items of data to be displayed in association with the identification information of the shot and a display order of each item are able to be set by a user operation.

8. The information processing device according to claim 1, wherein the display unit displays a setting value of a molding condition for the shot, which is the information related to the shot, and the estimated data of the same item as the setting value in comparison with each other.

9. The information processing device according to claim 1, wherein the estimated data displayed by the display unit includes at least any one of a value representing a state of a product, a value representing a state of a mold, a value representing a state of a machine, a setting value of a new molding condition, and an amount of change in the molding condition.

10. The information processing device according to claim 1, further comprising:
a processing unit that acquires information related to an operation of injection molding from an injection unit and a mold clamping unit and that estimates estimated data of information indicating a molding result in a shot in injection molding based on the acquired information,
wherein the display unit displays, for each shot, the information acquired by the acquisition unit and the estimated data in the shot estimated by the processing unit in association with each other.

11. The information processing device according to claim 10, wherein
the processing unit estimates the estimated data using an estimation model trained by machine learning, and input data in the estimation model is a representative value of actual values of information indicating, for each shot, a molding result in the shot.

12. The information processing device according to claim 10, wherein
the processing unit estimates the estimated data using an estimation model trained by machine learning, and
input data in the estimation model is time-series data of actual values of information indicating, for each shot, a molding result in the shot.

13. The information processing device according to claim 10, wherein the processing unit stores the estimated data in a storage device as a data file in association with actual values of information indicating a molding result for each shot and setting values of a molding condition.

14. An injection molding machine comprising:
an injection unit;
a mold clamping unit;
a data processing device that estimates estimated data of information indicating a molding result in a shot for each shot in injection molding based on information related to an operation of the injection molding by the injection unit and the mold clamping unit; and
a display unit that displays, for each shot, information related to the shot and the estimated data in the shot in association with each other.

15. A non-transitory computer readable medium storing a program, the program when executed by a processor, cause the processor to:
acquire information related to an operation of injection molding from an injection unit and a mold clamping unit;
estimate estimated data of information indicating a molding result in a shot based on the information acquired for each shot in the injection molding; and
display, for each shot, the information related to the acquired shot and the estimated data in the shot in association with each other.
